(19) United States
(12) Patent Application Publication
(10) Pub. No.: US 2024/0187936 A1
(43) Pub. Date: Jun. 6, 2024

(54) A METHOD AND APPARATUS FOR DETERMINING SIDELINK RESOURCE

(71) Applicant: SAMSUNG ELECTRONICS CO., LTD., Suwon-si, Gyeonggi-do (KR)

(72) Inventors: Miao ZHOU, Beijing (CN); Feifei SUN, Beijing (CN); Yi WANG, Beijing (CN)

(21) Appl. No.: 18/553,158

(22) PCT Filed: Mar. 30, 2022
(86) PCT No.: PCT/KR2022/004514

§ 371 Date: Sep. 28, 2023

(30) Foreign Application Priority Data
Apr. 2, 2021 (CN) 202110363604.2

(51) Int. Cl. H04W 28/26; H04W 72/02; H04W 72/40; H04W 76/28

(52) U.S. Cl. CPC H04W 28/26; H04W 72/02; H04W 72/40; H04W 76/28

(57) ABSTRACT

The disclosure relates to a 5G or 6G communication system for supporting a higher data transmission rate. The application discloses a method and apparatus for determining sidelink resource, the method comprising: determining a resource allocation scheme for transmitting sidelink signal or sidelink channel by a first node; and determining a resource for transmitting the sidelink signal or the sidelink channel based on the determined resource allocation scheme.

### TECHNICAL FIELD

The present application relates to the field of wireless communication technology, and more specifically, to a method and apparatus for transmitting sidelink (SL) data and corresponding sidelink feedback messages in sidelink communication in the fifth generation new radio access technology (5G NR) system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to meet the increasing requirement for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The aspects and advantages of the embodiments of the present disclosure will be partially described in the following description, or can be learned from the description, or can be learned through the implementation of the embodiments.

The application provides a method for determining a resource allocation scheme which is actually applied when multiple resource allocation schemes are supported in the sidelink communication system. For example, it is determined based on characteristics such as scenario, user equipment (UE) capability, service parameters, etc.

In addition, the resource selection process in the sidelink communication system also needs to be further optimized.

### Solution to Problem

According to the embodiment of the application, a method for determining sidelink resource is proposed. The method includes: determining a resource allocation scheme for transmitting sidelink signal/channel by a first node, and determining resource for transmitting the sidelink signal/channel based on the determined resource allocation scheme.

According to an embodiment of the present application, a resource selection process is performed based on coordination information from other nodes for determining sidelink transmission resource.

With the method of the application, the UE can select a resource allocation scheme that is more suitable for the current transmission according to the characteristics related to the sidelink transmission, so as to improve the performance of the current transmission and reduce the system power consumption.

In addition, according to the embodiment of the present application, the process of performing resource selection can become simpler, which helps to reduce cost and power consumption, and the performance of the selected resource can also be better.

The above and other features, aspects and advantages of various embodiments of the present disclosure will be better understood with reference to the following description and the appended claims. The accompanying drawings of the specification constituting a part of the present disclosure illustrate example embodiments of the present disclosure and are used together with the description to explain relevant principles. The details of one or more implementations on the subject of the present invention are set forth in the accompanying drawings of the specification and the following description. Through these descriptions, drawings and claims, other potential features, aspects and advantages of the subject matter of the invention will also become clear.

### Advantageous Effects of Invention

The application provides a method for determining a resource allocation scheme which is actually applied when multiple resource allocation schemes are supported in the sidelink communication system. For example, it is determined based on characteristics such as scenario, user equipment (UE) capability, service parameters, etc.

In addition, the resource selection process in the sidelink communication system also needs to be further optimized.

### BRIEF DESCRIPTION OF DRAWINGS

FIG. 1 illustrates an example wireless network 100 according to various embodiments of the present disclosure;

FIG. 2a illustrates an example wireless transmission and reception path according to the present disclosure;

FIG. 2b illustrates an example wireless transmission and reception path according to the present disclosure;

FIG. 3a illustrates an example UE according to the present disclosure;

FIG. 3b illustrates an example gNB according to the present disclosure;

FIG. 4 is a flowchart showing a method according to an example embodiment of the present disclosure;

FIG. 5a schematically illustrates embodiment 1 according to the present disclosure;

FIG. 5b schematically illustrates an implementation according to embodiment 1 of the present disclosure;

FIG. 5c schematically illustrates another implementation according to embodiment 1 of the present disclosure;

FIG. 5d schematically illustrates another implementation according to embodiment 1 of the present disclosure;

FIG. 6 schematically illustrates embodiment 2 according to the present disclosure;

FIG. 7 illustrates a structure of a UE according to an embodiment of the disclosure; and

FIG. 8 illustrates a structure of a base station according to an embodiment of the disclosure.

### BEST MODE FOR CARRYING OUT THE INVENTION

According to various embodiments, a method performed by a first node for determining sidelink resource, the method comprising: determining a resource allocation scheme for transmitting sidelink signal or sidelink channel by a first node; and determining a resource for transmitting the sidelink signal or the sidelink channel based on the determined resource allocation scheme.

According to various embodiments, a first node device for determining sidelink resource, comprising: a memory, which is configured to store a computer program; and
a processor, wherein the processor is configured to: determine a resource allocation scheme for transmitting sidelink signal or sidelink channel by a first node; and
determine a resource for transmitting the sidelink signal or the sidelink channel based on the determined resource allocation scheme.

### MODE FOR THE INVENTION

Definitions of certain words and terms are given in the description of the present disclosure. Those of ordinary skill in the art should understand that, in many cases (if not in most cases), such definitions are applicable to the use of such defined words and terms in various situations in the past and in the future. Unless otherwise specified, the terms used in the present disclosure have the same meanings as understood by those of ordinary skill in the art to which the present disclosure belongs. For example, the terms of those terms defined in commonly used dictionaries should be interpreted as having the same meaning as the context in the relevant field, and should not be interpreted as having a transitional idealized or formalized meaning.

Although terms including ordinal numbers such as “first” and “second” are used to describe various elements (for example, components, steps, etc.), these elements are not limited by these terms. These terms are only used to distinguish one element from another. Therefore, these terms may be used interchangeably without departing from the scope of the present disclosure. For example, the first element may be referred to as the second element, and similarly, the second element may also be referred to as the first element. In addition, as used herein, the terms “/”, “or”, “and/or” are intended to include any and all combinations of one or more related items.

By referring to the following detailed description of the various embodiments and the accompanying drawings in the specification, the aspects and features of the present disclosure and the implementation thereof can be understood more clearly. However, the present disclosure may be embodied in many different forms, and should not be construed as being limited to the various embodiments set forth herein. Rather, these embodiments are provided to make the present disclosure full and complete, and to fully convey the principles and concepts of the present disclosure to those skilled in the art. Therefore, those of ordinary skill in the art should recognize that various modifications, adjustments, combinations and substitutions can be made to the various embodiments described in the present disclosure without departing from the spirit and scope of the present disclosure. Moreover, these modifications, adjustments, combinations and substitutions should also be considered to be included in the scope of protection of this application as defined by the claims.

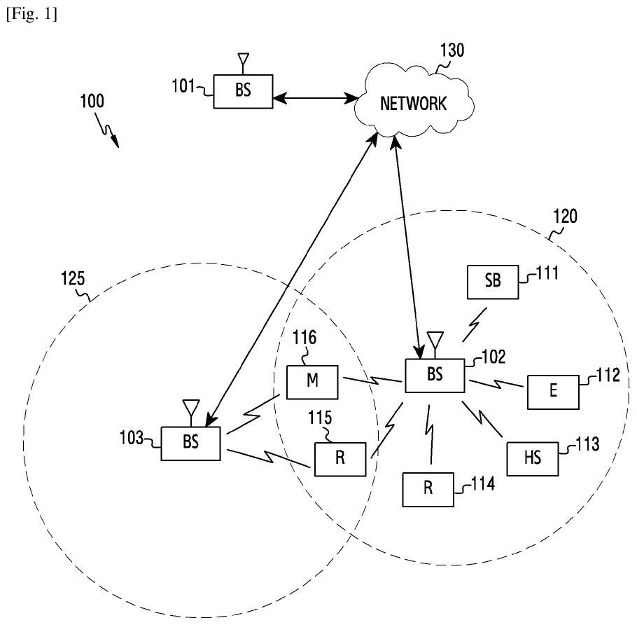

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

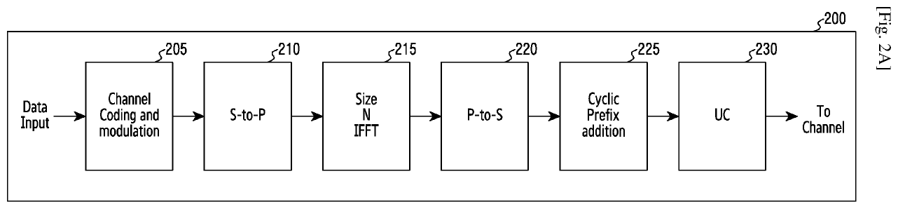

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

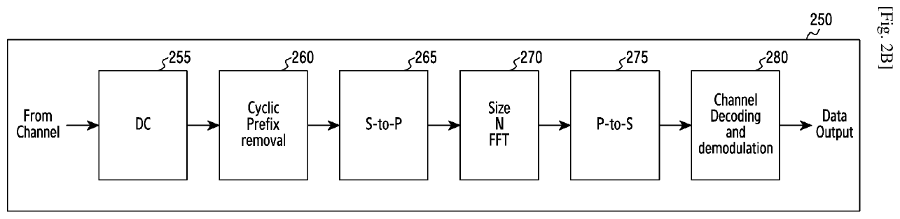

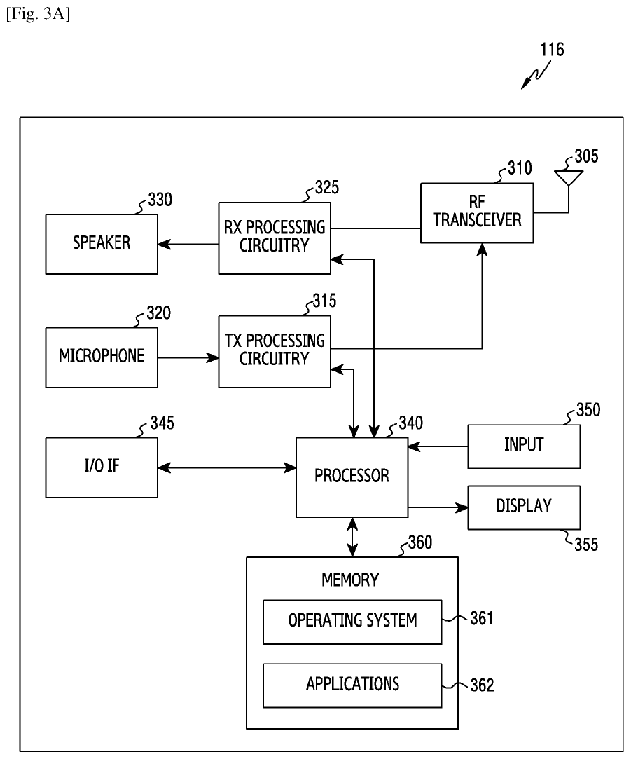

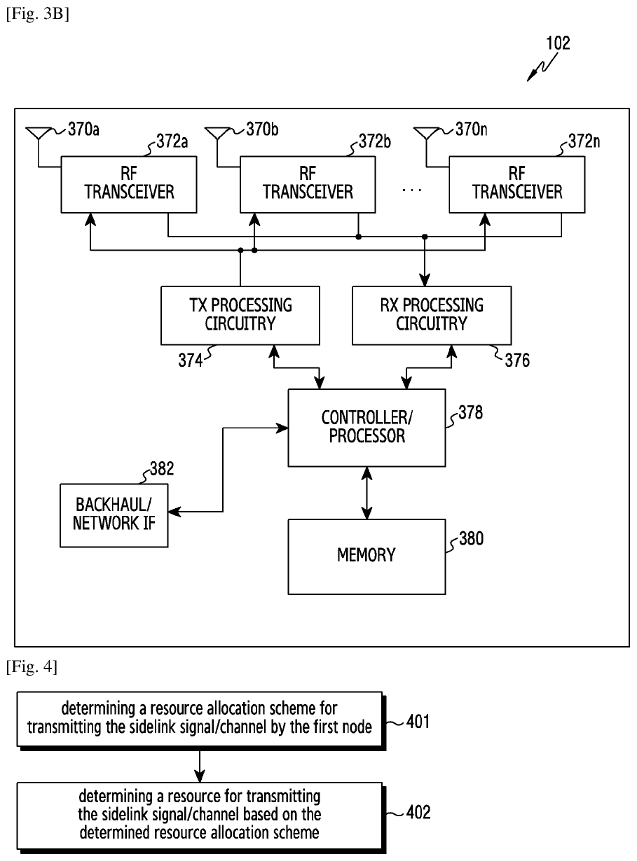

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In long term evolution (LTE) technology, the sidelink communication includes two main mechanisms: Device to Device (D2D) direct communication and Vehicle to Vehicle/Infrastructure/Pedestrian/Network (collectively referred to as V2X). V2X is designed on the basis of D2D technology. It is superior to D2D in terms of data rate, latency, reliability, link capacity, etc., and is the most representative sidelink communication technology in LTE technology. In the 5G system, the sidelink communication currently mainly includes vehicle-to-outside (V2X) communication.

NR V2X system defines several sidelink physical channels, including Physical Sidelink Control Channel (PSCCH), Physical Sidelink Shared Channel (PSSCH) and Physical Sidelink Feedback Channel (PSFCH). PSSCH is used to carry the data, PSCCH is used to carry Sidelink control information (SCI), the SCI indicates the time-frequency domain resource position of the associated PSSCH transmission, modulation and coding mode, receiving destination ID for PSSCH and other information, and PSFCH is used to carry HARQ-ACK information corresponding to the data.

In NR V2X system, at present, the slot in 5G system is used as the minimum unit of time domain resource allocation, and sub-channel is defined as the minimum unit of frequency domain resource allocation. One sub-channel is configured as several RBs in frequency domain, and one sub-channel may include resource corresponding to at least one of PSCCH, PSSCH, and PSFCH.

From the perspective of resource allocation, 5G sidelink communication system includes two modes: a resource allocation mode based on base station scheduling and a resource allocation mode independently selected by UE. In 5G V2X system, the resource allocation mode based on base station scheduling and the resource allocation mode independently selected by UE are referred to as mode 1 and mode 2 respectively.

For mode 1, the method for the base station to schedule resource for the sidelink UE is to transmit a sidelink grant to the sidelink UE, and several or periodic sidelink resources used for the sidelink UE are indicated in the sidelink grant. The sidelink grant includes dynamic grant and configured grant, wherein the dynamic grant is indicated by DCI, the configured grant further includes the configured grant of type 1 and type 2, the configured grant of type 1 is indicated by RRC signaling, and the configured grant of type 2 is indicated by RRC signaling and activated/deactivated by DCI.

For mode 2, the method for the sidelink UE to independently select resource is that the UE always keeps monitoring and buffering of the sidelink resource pool, and determines one channel sensing time window and one resource selection time window according to the expected time range of sending the sidelink transmission before the sidelink transmission needs to be sent, and performs channel sensing in the channel sensing time window, excludes the sidelink resource that has been reserved by other sidelink UEs in the resource selection time window according to the result of channel sensing, and randomly selects the resource for the sidelink transmission from the sidelink resources which are not excluded in the resource selection time window.

Currently, the UE performs channel sensing based on its buffered sidelink transmissions received on all resources in the sidelink resource pool. However, the premise of this method is that the UE has the requirement to receive sidelink services and is not sure at what time point it will receive the sidelink transmission sent to it. Therefore, it is necessary to continuously monitor each slot in the sidelink resource pool, receive and buffer all possible sidelink transmissions. Since the UE will not skip any monitoring on a sidelink slot (except for cases where it cannot be monitored due to limitations in UE capabilities such as half duplex/receiving downlink transmissions, which are not in the scope of skip monitoring), resulting in high power consumption for monitoring.

If the above premise cannot be established for a specific type of V2X UE, for example, some Pedestrian UE (P-UE) and Infrastructure UE (I-UE) may not have the requirement to receive sidelink services but only have the requirement to send sidelink services, the sidelink resource can be monitored only for the purpose of channel sensing, so as to reduce the range of the UE to monitor the sidelink resource and reduce power consumption.

The current UE is mainly Vehicle UE (V-UE), which is relatively insensitive to power consumption, so it can run smoothly. However, in order to expand the market scope and improve the system performance, V2X technology needs to be applied to more types of UEs, such as Pedestrian UE (P-UE). Therefore, it is beneficial to enhance channel sensing technology for the purpose of reducing power consumption.

Some specific channel sensing technologies, such as some sensing technologies and similar mechanisms in LTE V2X system, have certain limitations in their applicable scenarios. For example, LTE V2X partial sensing is suitable for periodic services of transmitting UE, while for burst services of transmitting UE, since it is difficult to expect the time point of burst services, some sensing technologies may be difficult to determine the corresponding sensing window before the burst service arrives, so it is difficult to implement. Therefore, the sidelink communication system may support a variety of resource allocation schemes based on channel sensing and/or not based on channel sensing, and apply different schemes in different scenarios.

The exemplary embodiments of the present disclosure are further described below with reference to the accompanying drawings.

The text and the accompanying drawings are provided only as examples to help readers understand the present disclosure. They are not intended and should not be construed as limiting the scope of the present disclosure in any way. Although some embodiments and examples have been provided, based on the contents disclosed herein, it is obvious to those skilled in the art that the embodiments and examples shown can be modified without departing from the scope of the present disclosure.

The slot in the embodiment of the application can be either a subframe or slot in the physical sense or a subframe or slot in the logical sense. Specifically, the subframe or slot in the logical sense is the subframe or slot corresponding to the resource pool of sidelink communication. For example, in V2X system, the resource pool is defined by a repeated bitmap, which is mapped to a specific set of slots. The specific set of slots can be all slots or all other slots except some specific slots (such as the slot for transmitting MIB/SIB). The slot indicated as “1” in the bitmap can be used for V2X transmission and belongs to the slot corresponding to V2X resource pool; the slot indicated as “0” cannot be used for V2X transmission and does not belong to the slot corresponding to the V2X resource pool.

The following is a typical application scenario to illustrate the difference between the physical or logical subframes or slots: when calculating the time domain gap between two specific channels/messages (such as PSSCH carrying sidelink data and PSFCH carrying corresponding feedback information), it is assumed that the gap is N slots. If the physical subframe or slot is calculated, the N slots correspond to the absolute time length of N*x milliseconds in the time domain, x is the time length of the physical slot (subframe) under the numerology of the scenario in millisecond; otherwise, if the subframe or slot in the logical sense is calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot in the embodiment of the present application can be a complete slot or several symbols corresponding to the sidelink communication in one slot. For example, when the sidelink communication is configured to be performed on the X1-X2 symbols of each slot, the slot in the following embodiment is the X1-X2 symbols in the slot in this scenario; alternatively, when the sidelink communication is configured as mini slot transmission, the slot in the following embodiment is a mini slot defined or configured in the sidelink system rather than a slot in the NR system; alternatively, when the sidelink communication is configured as symbol level transmission, the slot in the following embodiment may be replaced with a symbol, or may be replaced with N symbols of time domain granularity as symbol level transmission.

In the embodiment of this application, the information configured by the base station, indicated by the signaling, configured by the higher layer, and pre-configured includes a group of configuration information; it also includes multiple groups of configuration information, and the UE selects a group of configuration information for use according to predefined conditions; it also includes a group of configuration information including multiple subsets, from which UE selects a subset for use according to predefined conditions.

Some of the technical solutions provided in the embodiments of the application are specifically described based on V2X system, but the application scenario thereof should not be limited to V2X system in the sidelink communication, but can also be applied to other sidelink transmission systems. For example, the design based on the V2X subchannel in the following embodiments can also be used for D2D subchannel or other sidelink transmission subchannel. The V2X resource pool in the following embodiments can also be replaced with a D2D resource pool in other sidelink transmission systems, such as D2D.

In the embodiment of the application, when the sidelink communication system is V2X system, the terminal or UE can be various types of terminals or UEs such as Vehicle, Infrastructure, Pedestrian, etc.

In order to make the objectives, technical solutions, and advantages of the present application clearer, the implementation of the present application will be further described in detail below in conjunction with the accompanying drawings.

In the embodiment of the present application, lower than the threshold can also be replaced by at least one of higher than the threshold, lower than or equal to the threshold and higher than or equal to the threshold; higher than (exceeding) the threshold may also be replaced by at least one of lower than the threshold, lower than or equal to the threshold, and higher than or equal to the threshold. Lower than or equal to may also be replaced by at least one of lower than, higher than, higher than or equal to, or equal to; higher than or equal to may also be replaced with at least one of lower than, higher than, lower than or equal to, or equal to.

FIG. 4 is a flowchart showing a method according to an example embodiment of the present disclosure, including the following steps:

Step 401: determining a resource allocation scheme for transmitting the sidelink signal/channel by the first node;

Step 402: determining a resource for transmitting the sidelink signal/channel based on the determined resource allocation scheme.

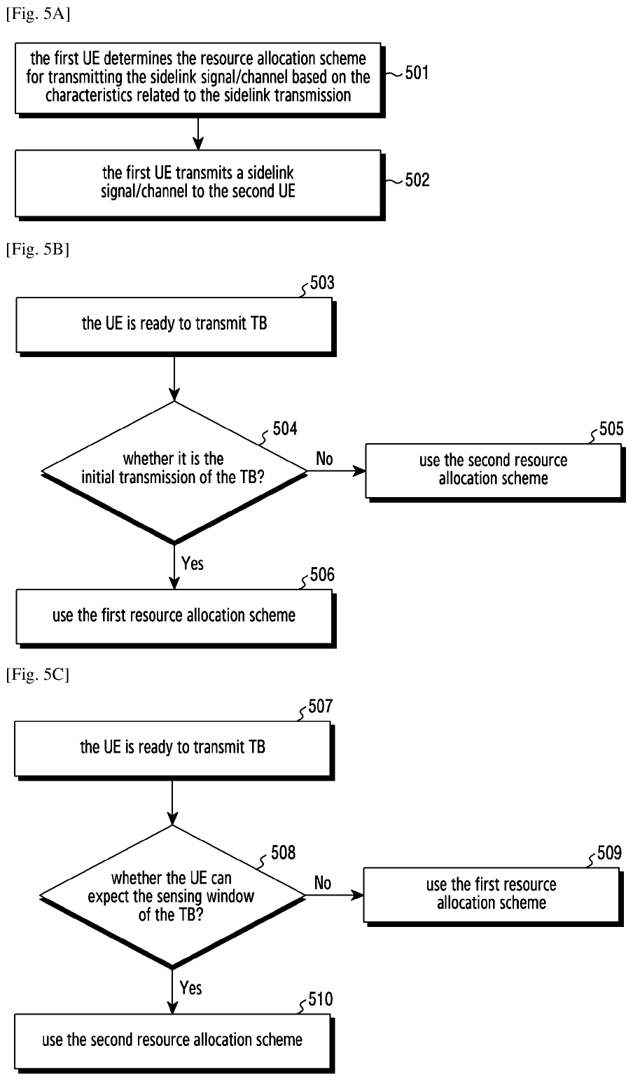

FIG. 5a schematically illustrates embodiment 1 according to the present disclosure.

In this embodiment, in the sidelink communication system, feasible resource allocation schemes include full sensing, partial sensing, random selection, re-evaluation, pre-emption, etc. Wherein, the full sensing mainly means that UE receives and buffers all resources in the configured sidelink resources. The advantage of this method is that the sensing information collected is the most sufficient. For any sidelink transmission, the UE assumes that its corresponding sensing window has been buffered by the UE, and based on full sensing, the UE can detect as many potential conflicts as possible with other sidelink UEs; however, the power consumption caused by full sensing is high, so it is more suitable for UEs that are not sensitive to power consumption, such as vehicle nodes whose communication module has on-board power supply.

The partial sensing mainly means that the UE receives and buffers only some of the resources in the configured sidelink resources; generally, the some of the resources corresponds to the sensing window of all transmissions initiated by the UE or the sensing window of all transmissions initiated by the UE belongs to a subset of this part of the resource. The advantage of this method is that the power consumption corresponding to receiving and buffering by UE is lower, which helps UE save power. However, compared with full sensing, if the partial sensing pursues lower power consumption, it needs to reduce the scope of detecting potential conflicts. Therefore, it is likely to sacrifice part of the performance of avoiding conflicts. In the protocol, the full sensing and the partial sensing can correspond to different sensing window calculation methods.

Further, the partial sensing/full sensing may also include periodic sensing (window) and/or continuous sensing (window). The periodic sensing mainly refers to that the sensing window, corresponding to at least one resource in the resource selection window, includes periodic occasion(s) of sensing resources. Continuous sensing mainly refers to that the sensing window, corresponding to the resource selection window or at least one resource in the resource selection window, includes at least one continuous time window. The periodic sensing and/or the continuous sensing may be used in combination, for example, one resource selection window or at least one resource in the resource selection window corresponds to a periodic sensing window and a continuous sensing window; or can be used separately.

Compared with the resource allocation schemes based on sensing, the random selection mainly refers to a resource allocation scheme that is not based on sensing information (or can be partially based on sensing information). When the UE uses resource allocation based on the random selection, it usually determines the set of the candidate resources based on the related parameters such as load size of the data, arrival time, latency requirement, as well as the characteristics such as UE capability, and randomly selects the resource actually used for transmission in the set of the candidate resources. This process generally does not involve the exclusion of the candidate resources based on channel sensing, or it can also involve the exclusion of the candidate resources based on channel sensing, but does not introduce a dedicated sensing window. The advantage of this method is that it does not introduce the power consumption caused by channel sensing, and because this method does not require sufficient sensing results, it can be used in any scenario. In addition, due to skipping the sensing process, the latency of initial transmission may be lower when using this method; however, compared with the transmission based on sensing, since the random selection method cannot avoid potential conflicts with other UEs, the performance of its single transmission may be worse than that of the transmission based on sensing, resulting in performance degradation or leads to more retransmissions.

Re-evaluation and pre-emption occur after the UE selects the resource for the sidelink transmission. Re-evaluation mainly refers to when the UE has selected a resource for the sidelink transmission, and has not transmitted on this resource, and has not reserved the resource in previous transmissions, it decides to give up using the resource because it detects that there is a conflict on the resource. At this time, the UE can reselect another resource for the sidelink transmission. Pre-emption is similar to re-evaluation, but it mainly means that after the UE has reserved resource for the sidelink transmission by means of signaling indication, it decides to give up using the resource because it detects that there is a conflict on the resource. At this time, the UE can reselect another resource for sidelink transmission.

Since the sidelink system may support the above multiple resource allocation schemes, the UE needs to determine which resource allocation scheme to use under what conditions and/or which resource allocation scheme should be used for a specific transmission. Accordingly, the present embodiment provides a method for determining a resource allocation scheme used.

In this embodiment, the first UE serves as the transmitter of the sidelink data and the second UE serves as the receiver of the sidelink data. In this specification, the second UE may also be replaced by one or more communication nodes, which may be a UE or a base station. When the first UE transmits a sidelink signal/channel to the second UE (502), it is necessary to determine the resource allocation scheme used for transmission of the sidelink signal/channel. Alternatively, if the first UE enables mode 2, that is, the UE independently determines the resource transmission mode, and/or the first UE has the ability to support more than one resource allocation schemes, and/or is configured to enable more than one resource allocation schemes, when the first UE transmits a sidelink signal/channel to the second UE, it needs to determine the resource allocation scheme used for transmission of the sidelink signal/channel. The sidelink signal/channel includes PSSCH and/or PSCCH. The resource allocation scheme includes at least one of the following: full sensing, partial sensing, random selection, re-evaluation and pre-emption. Wherein, the partial sensing may include periodic-based partial sensing and/or contiguous partial sensing. Wherein, the full sensing and/or the partial sensing can include sensing before and/or after the data arrives at the physical layer and/or the higher layer triggers the physical layer to start the resource selection process (or start the sensing process, which can be similarly replaced in other parts in the full text of the specification and will not be repeated).

The first UE determines the resource allocation scheme for transmitting the sidelink signal/channel based on the characteristics related to the sidelink transmission (501). Specifically, the first UE determines the resource allocation scheme used for transmitting the sidelink signal/channel based on at least one of the followings:
the resource allocation scheme indicated in the configuration, which includes at least one of UE/UE group-specific configuration, resource pool-specific configuration, transmitter-specific configuration and receiver-specific configuration;
the type of the sidelink signal/channel;
the priority corresponding to the sidelink signal/channel, further including at least one of a physical layer priority and a higher layer priority;
the latency corresponding to the sidelink signal/channel, which can be indicated by the remaining packet delay budget (PDB) parameter and/or derived from the service priority;
previous sensing results, and/or existing sensing results, and/or sensing results that can be used for transmission of the sidelink signal/channel;
previous resource used for sensing, and/or existing resource used for sensing, and/or resource used for sensing that can be used for transmission of the sidelink signal/channel;
whether available resource, and/or unavailable resource, and/or sensing results are obtained, which can be indicated by the base station or other UE, and the indication can be included in the coordination information;
DRX configuration, including DRX configuration of the first UE and/or DRX configuration of the second UE;
hybrid automatic repeat request acknowledgement (HARQ-ACK) status, including whether the HARQ-ACK error rate of PSSCH or other sidelink signal/channel transmitted by the first UE exceeds the threshold, and/or whether the number of continuous or discontinuous NACKs received by the first UE (within a specific time range) exceeds the threshold;
power saving status, including power saving level and/or battery remaining;
whether data is the initial transmission or retransmission, including the initial transmission/retransmission of transport block (TB).

When at least one or a specific combination of the above items meets the preset conditions, the UE uses one or more resource allocation schemes; otherwise, the UE uses another one or more resource allocation schemes.

Wherein, determining the resource allocation scheme used for transmitting the sidelink signal/channel based on the previous sensing results, and/or the existing sensing results, and/or the sensing results that can be used for transmission of the sidelink signal/channel, includes: determining the resource allocation scheme based on whether the number of the previous sensing results, and/or the existing sensing results, and/or the sensing results that can be used for transmission of the sidelink signal/channel exceeds the threshold. Wherein, determining the resource allocation scheme used for transmitting the sidelink signal/channel based on the previous resource used for sensing, and/or the existing resource used for sensing, and/or the resource used for sensing that can be used for transmission of the sidelink signal/channel, includes: determining the resource allocation scheme based on whether the number of previous resource used for sensing, and/or the existing resource used for sensing, and/or the resource used for sensing that can be used for transmission of the sidelink signal/channel exceeds the threshold. The number of sensing results includes the number of resources (such as one subchannel and/or one slot) corresponding to the sensing results for performing sensing, and/or the number of SCIs indicating resource reservation in the sensing results. Wherein, the threshold may correspond to the percentage of the previous sensing results, and/or the existing sensing results, and/or the sensing results that can be used for transmission of the sidelink signal/channel occupying the sensing window.

For the transmission of the sidelink signal/channel, for the resource included in the sensing window corresponding to certain resource allocation scheme, if the UE performs sensing on the resource or buffers the signal received on the resource, the sensing result on the resource is the previous sensing result and/or the existing sensing result, and/or the resource is the previous and/or existing resource. Alternatively, for the resource included in the sensing window corresponding to a certain resource allocation scheme, if the UE performs sensing on the resource, and the parameters or subsets of parameters (such as TBS, priority, frequency domain resource size) used by the UE to perform sensing are the same as the values of the above parameters corresponding to the sidelink signal/channel, or the offset of the value of the above parameters corresponding to the sidelink signal/channel is within a specific range, the sensing result on the resource is the previous/existing sensing result. Alternatively, according to the UE capability (for example, whether the UE is capable of buffering the reception on the resource and/or whether the UE is capable of buffering the sensing result), the judgment criterion adopted by the UE when determining whether the sensing result on the resource is the previous/existing sensing result is that the sensing is performed on the resource or the signal received on the resource is buffered.

For the transmission of the sidelink signal/channel, for the resource included in the sensing window corresponding to a certain resource allocation scheme, if the UE can perform sensing on the resource, it is considered that the sensing result on the resource is the sensing result that can be used for transmission of the sidelink signal/channel, and/or it is considered that the resource is the resource used for sensing that can be used for transmission of the sidelink signal/channel. Further, when at least one or a particular combination of the following conditions is satisfied, the UE determines that sensing can be performed on the resource, and/or considers that the sensing result on the resource is the sensing result that can be used for transmission of the sidelink signal/channel, and/or considers that the resource is the resource used for sensing that can be used for transmission of the sidelink signal/channel:
the resource is later than the current time point in time domain; for example, the UE determines that the sensing window includes slot n+n1 on slot n, and/or the UE obtains data from the higher layer on slot n or is triggered by the higher layer to start resource selection. If n1>0 (or greater than or equal to 0), it is considered that slot n+n1 is later than the current time point in time domain;
the UE does not need to transmit other signal/channel on this resource;
the resource is during DRX-on period; for example, at least one DRX timer is running at the time when the specific resource is located;
the resource is during DRX-on or off period, and the UE can perform sensing during DRX-on or off period.

In this embodiment, the resource allocation scheme used by the first UE to transmit the sidelink signal/channel may be a combination of the following embodiments. For example, if the resource allocation scheme used by the first UE to transmit the sidelink signal/channel meets the conditions in some embodiments below, the sensing window corresponding to the resource allocation scheme in some embodiments is used. If the resource allocation scheme used by the first UE to transmit the sidelink signal/channel meets the conditions in other embodiments below, the sensing window corresponding to the resource allocation scheme in other embodiments is used. Therefore, the sensing window corresponding to the resource allocation scheme used by the first UE to transmit the sidelink signal/channel includes the union of the sensing windows corresponding to the resource allocation scheme in some embodiments and other embodiments.

FIG. 5b schematically illustrates an implementation according to embodiment 1 of the present disclosure, which will be described in detail below with reference to FIG. 5b.

In other implementations of the present embodiment, the UE is configured to use a first resource allocation scheme and a second resource allocation scheme. As shown in FIG. 5b, the UE is ready to transmit one TB (503) and determines whether it is the initial transmission of the TB (504). The UE uses the first resource allocation scheme for the initial transmission of one TB (506) and the second resource allocation scheme for the retransmission of the TB (505).

In this embodiment, the first resource allocation scheme may be random selection and/or re-evaluation and/or pre-emption, and the second resource allocation scheme may be partial sensing and/or re-evaluation and/or pre-emption. Alternatively, if the priority corresponding to the TB meets the predetermined threshold range, and/or if the remaining PDB corresponding to the TB meets the predetermined threshold range, the UE uses the random selection and/or the re-evaluation and/or the pre-emption for the initial transmission of a specific TB and uses the partial sensing for the retransmission of the TB. The advantage of this method is that when the data in the TB arrives the physical layer and/or is triggered by the higher layer to start the resource selection process, the UE may not have sufficient sensing results to determine the resource used for the initial transmission of the TB. If the initial transmission uses the resource allocation scheme based on sensing, the UE may need to continue to perform sensing for a period of time before determining the resource for the initial transmission, thereby increasing the transmission latency. Therefore, in this method, the random selection is used for the initial transmission to reduce the latency of the initial transmission. In addition, when the priority of the TB is high (for example, the above threshold range is priority>specific threshold), other UEs may actively avoid the conflict with the data with higher priority when transmitting data with lower priority, so that the transmission performance of the TB will not be significantly reduced; for subsequent retransmissions, the UE can maintain sensing after starting the resource selection process, so as to provide more sufficient sensing results (compared with the initial transmission) for subsequent retransmissions to determine transmission resource. Therefore, the resource allocation scheme based on sensing has better performance and will not introduce additional latency.

In this embodiment, the first resource allocation scheme may also be the full sensing and/or the re-evaluation and/or the pre-emption, and the second resource allocation scheme may be the partial sensing. The advantage of this method is that since the initial transmission of TB uses the full sensing, the UE will keep monitoring the sidelink resource pool before the data in the TB arrives the physical layer and/or is triggered by the higher layer to start the resource selection process. Therefore, the initial transmission of TB has the same performance as that in the traditional system using full sensing. For the subsequent retransmission of the TB, the UE uses the partial sensing. Since the UE can also maintain sensing after starting the resource selection process, and can directly reuse the previous sensing results when the sensing window corresponding to the subsequent retransmission of the TB coincides with the previous monitoring, its benefits are similar to those in the previous paragraph.

In other embodiments, the higher layer configures the UE to switch between the full sensing/the partial sensing/the random selection, and configures whether the UE will also use the re-evaluation/the pre-emption for any of full sensing/partial sensing/random selection. The configuration may be semi-static, for example effective for a period of time after the configuration, and/or always effective, and/or effective for a specific UE (which can be indicated by the destination ID), and/or effective for a specific resource pool; it may also be dynamic, for example, effective for the current one transmission, and/or multiple transmissions of the current one TB, and/or multiple transmissions within the current configured grant period, and/or for the transmission indicated in one SCI.

FIG. 5c schematically illustrates another implementation according to embodiment 1 of the present disclosure, which will be described in detail below with reference to FIG. 5c.

In other implementations of the present embodiment, the UE is configured to use a first resource allocation scheme and a second resource allocation scheme. As shown in FIG. 5c, the UE is ready to transmit one TB (507) and determines whether the sensing window of the TB (508) can be expected. When the sensing window of the TB can be expected, the UE uses the second allocation scheme (510), otherwise uses the first resource allocation scheme (509).

Wherein, the case where the UE can expect that the sensing window of the TB includes at least one of the followings:
the UE determines that the sensing window of the TB is before the UE being triggered to start the resource selection process, and the UE can expect when it is triggered to start the resource selection process. For example, if the higher layer delivers one TB to the physical layer (e.g. in slot n) and provides the resource reservation period corresponding to the TB (e.g. Pᵣₛᵥₚ in the prior art), the UE can expect that after the length of the resource reservation period (e.g. in slot n+Pᵣₛᵥₚ), the higher layer will deliver the next TB to the physical layer. Therefore, when the higher layer delivers the TB to the physical layer, it also provides a resource reservation period, which can be regarded as one of the conditions for the UE to use the second allocation scheme;
the UE determines that the sensing window of the TB is after the UE being triggered to start the resource selection process. Alternatively, the UE determines that at least a part of the sensing window of the TB exists after the UE is triggered to start the resource selection process. Alternatively, the proportion of the part of the sensing window in the whole sensing window meets the threshold range, or the number of slots/time-frequency resources/candidate resources included in the part of the sensing window meets the threshold range;
the UE determines that the sensing window of the TB is after the UE being triggered to start the resource selection process and the latency (for example, the remaining PDB) corresponding to the TB is sufficient to accommodate the UE to start the resource selection process for sensing. For example, the latency (for example, the remaining PDB) corresponding to TB is greater than a threshold, which can be priority specific. For another example, the remaining time after the latency corresponding to TB minusing the length of the resource selection window and minusing the UE processing latency is greater than the minimum size of the sensing window, which can be priority specific. For another example, the UE determines that at least part of the sensing window of the TB exists after the UE being triggered to start the resource selection process and does not exceed the latency requirement (for example, the part does not exceed the remaining PDB or the time after the part plusing the length of the resource selection window and plusing the UE processing latency does not exceed the remaining PDB). Alternatively, the proportion of this part of the sensing window in the whole sensing window meets the threshold range, or the number of slots/time-frequency resources/candidate resources included in this part of the sensing window meets the threshold range.

In this embodiment, the first resource allocation scheme may be the random selection and/or the full sensing and/or the re-evaluation and/or the pre-emption, and the second resource allocation scheme may be the partial sensing and/or the re-evaluation and/or the pre-emption. The advantage of this method is that if the UE can expect the sensing window of the TB, it can perform channel sensing on the expected sensing window and use the sensing results for resource selection based on the partial sensing. This method eliminates the need for the UE to monitor the sidelink resources on other slots outside the sensing window, thereby causing unnecessary power consumption overhead, and ensures the performance of resource selection based on sensing. If the UE cannot expect the sensing window of the TB, it uses the random selection to minimize power consumption overhead, or uses the full sensing to ensure transmission performance. Alternatively, in this embodiment, the first resource allocation scheme is determined based on the battery remaining, for example, the full sensing is used when the battery remaining is higher than the threshold, otherwise the random selection is used.

FIG. 5d schematically illustrates another implementation according to embodiment 1 of the present disclosure, which will be described in detail below with reference to FIG. 5d.

In other implementations of the present embodiment, the UE is configured to use a first resource allocation scheme and a second resource allocation scheme. As shown in FIG. 5d, after a specific TB arriving at the physical layer and/or the higher layer triggering the UE to start resource selection for the transmission of the specific TB, for any one transmission of the TB (including the initial transmission and retransmission) (511), if the number of sensing results corresponding to the transmission and/or the number of resources that can be used for sensing exceed the threshold (or meet the specific threshold range) (512), the second resource allocation scheme (514) is used for the transmission of the TB, otherwise the first resource allocation scheme (513) is used for the transmission of the TB.

Wherein, the sensing results corresponding to the transmission include at least one of the followings:

If at least one of the followings is satisfied, the result of UE performing sensing on the resource can be used as the sensing result corresponding to the transmission:
after determining the sensing window corresponding to the transmission, for any resource in the sensing window, the UE has buffered the sidelink signal received on the resource;
after determining the sensing window corresponding to the transmission, for any resource in the sensing window, the resource is later than the time point of determining the sensing window corresponding to the transmission, and/or later than the time point when the data of the UE arrives at the physical layer/UE is triggered by the higher layer to start the resource selection process. Alternatively, the time domain position of the resource needs to meet the latency requirements corresponding to the TB, and/or the position of the sensing window needs to meet the latency requirements corresponding to the TB, and/or the latency requirements corresponding to the TB meet the specific threshold range (for example, the remaining PDB corresponding to the TB is greater than X milliseconds);
after determining the sensing window corresponding to the transmission, for any resource in the sensing window, the resource is later than the time point of determining the sensing window corresponding to the transmission, and/or later than the time point when the data of the UE arrives the physical layer/the UE is triggered by the higher layer to start the resource selection process, and the UE can perform sensing on the resource. Alternatively, the time domain position of the resource needs to meet the latency requirements corresponding to the TB, and/or the position of the sensing window needs to meet the latency requirements corresponding to the TB, and/or the latency requirements corresponding to the TB meet the specific threshold range (for example, the remaining PDB corresponding to the TB is greater than X milliseconds). Wherein, the UE can perform sensing on the resource, including the resource is during the DRX-on period (which may be a period during which a clock corresponding to sensing is running), and/or the UE can perform sensing during the DRX-on or off period.

Alternatively, if the UE has performed sensing on the resource for the transmission of other sidelink signal/channel, and the resource size of the other sidelink signal/channel is the same as that of the TB, and/or other parameters affecting the sensing process, such as priority, Reference Signal Receiving Power (RSRP) threshold, etc., the sensing result of the other sidelink signal/channel on the resource can be used as the sensing result corresponding to the transmission.

Wherein, the resources that can be used for sensing include at least one of the followings:
after determining the sensing window corresponding to the transmission, for any resource in the sensing window, if the UE has buffered the sidelink signal received on the resource, the resource is the resources that can be used for sensing;
after determining the sensing window corresponding to the transmission, for any resource in the sensing window, if the resource is later than the time point of determining the sensing window corresponding to the transmission, and/or later than the time point when the data of the UE arrives at the physical layer/the UE is triggered by the higher layer to start the resource selection process, the resource is the resources that can be used for sensing. Alternatively, the time domain position of the resource needs to meet the latency requirements corresponding to the TB, and/or the position of the sensing window needs to meet the latency requirements corresponding to the TB, and/or the latency requirements corresponding to the TB meet the specific threshold range (for example, the remaining PDB corresponding to the TB is greater than X milliseconds).
after determining the sensing window corresponding to the transmission, for any resource in the sensing window, if the resource is later than the time point of determining the sensing window corresponding to the transmission, and/or later than the time point when the data of the UE arrives at the physical layer/the UE is triggered by the higher layer to start the resource selection process, and the UE can perform sensing on the resource, the resource is the resources that can be used for sensing. Alternatively, the time domain position of the resource needs to meet the latency requirements corresponding to the TB, and/or the position of the sensing window needs to meet the latency requirements corresponding to the TB, and/or the latency requirements corresponding to the TB meet the specific threshold range (for example, the remaining PDB corresponding to the TB is greater than X milliseconds). Wherein, the UE can perform sensing on the resource, including the resource is during the DRX-on period, and/or the UE can perform sensing during the DRX-on or off period.

The time domain position of resource needs to meet the latency requirements corresponding to the TB, including at least one of the followings:
the offset between the time domain position of the resource and the transmission time range of the TB or the latest transmission time point determined based on the latency requirement corresponding to the TB exceeds the threshold. For example, if the TB is transmitted to the physical layer in slot n and the value of the remaining PDB is x slots (x slots can be directly indicated by the higher layer or determined by converting the milliseconds indicated by the higher layer into slots), the latest transmission time point of the TB is slot n+x, or the transmission time range of the TB is [n+x-a, n+x-b], and a and b are (pre-)configured or fixed parameters. When the offset between the resource and n+x, or n+x-a and/or n+x-b exceeds the threshold, the time domain position of the resource needs to meet the latency requirements corresponding to the TB;
the offset between the time domain position of the resource and the resource selection window for sensing corresponding to the TB exceeds the threshold. Alternatively, the offset between the time domain position of the resource and the starting position of the resource selection window for sensing corresponding to the TB exceeds the threshold;
the offset between the time domain position of the resource and the set of the candidate resources for sensing corresponding to the TB exceeds the threshold. Alternatively, the offset between the time domain position of the resource and the resource with the earliest time domain position in the set of the candidate resources for sensing corresponding to the TB exceeds the threshold.

The position of the sensing window needs to meet the latency requirements corresponding to the TB, including at least one of the followings:
the time domain position of any resource in the sensing window needs to meet the latency requirements corresponding to the TB;
the time domain position of the latest time domain resource in the sensing window needs to meet the latency requirements corresponding to the TB;
the number of resource in the sensing window that meet the latency requirements corresponding to the TB exceeds the threshold;
the length or sum of the sensing window and/or resource selection window does not exceed the maximum latency corresponding to the TB;
the length of the sensing window and/or the resource selection window or the number of included resources/candidate resources exceeds the threshold.

In this embodiment, the first resource allocation scheme may be the random selection and/or the full sensing and/or the re-evaluation and/or the pre-emption, and the second resource allocation scheme may be the partial sensing and/or the re-evaluation and/or the pre-emption. The advantage of this method is that when the number of sensing results corresponding to the transmission and/or the number of the resources used for sensing exceed the threshold, the sensing results corresponding to the transmission can be considered to have sufficient reliability. Therefore, taking it as a condition for whether to adopt the partial sensing, can ensure the transmission performance when partial sensing is adopted. When the number of sensing results corresponding to the transmission and/or the number of resources used for sensing do not exceed the threshold, it is considered that the conditions are insufficient to adopt the partial sensing. At this time, it returns to the full sensing to ensure transmission reliability, or the random selection is used to enable the UE to independently select resources in the absence of sufficient sensing results. The advantages of the first resource allocation scheme including the random selection and including the full sensing are similar to those in other embodiments described above, respectively.

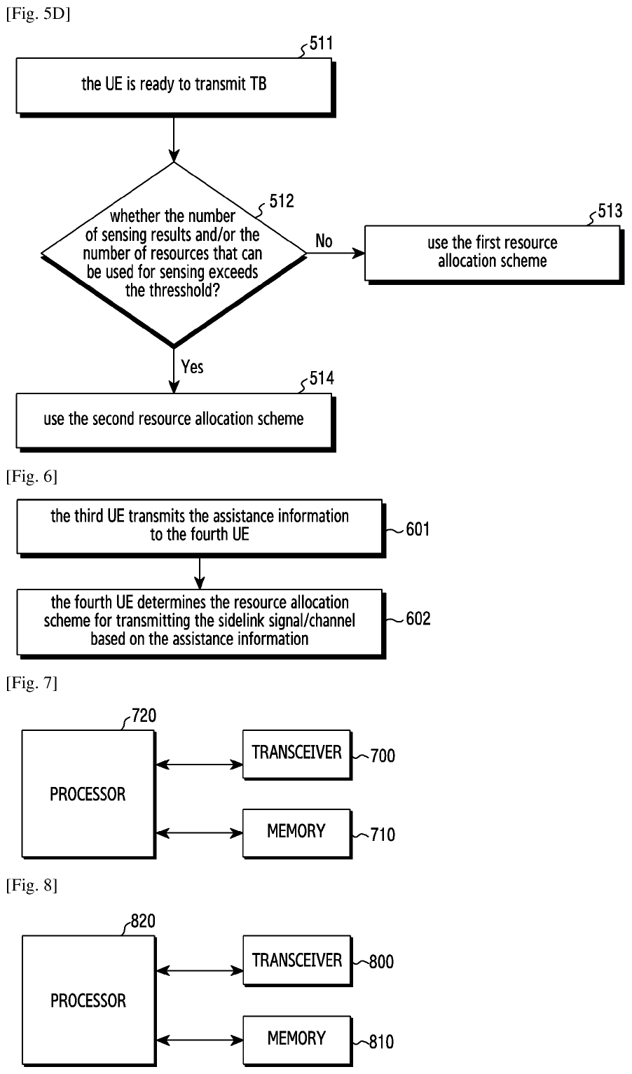

FIG. 6 schematically illustrates embodiment 2 according to the present disclosure.

In this embodiment, a class of information for mutual cooperation between sidelink UEs to determine transmission resource is introduced into the sidelink communication system, which is called coordination information. Generally speaking, the coordination information is transmitted by the third UE to the fourth UE (601), or may also be transmitted by the base station to the fourth UE. The coordination information may include information such as resource preferred by the third UE, resource not preferred by the third UE, sensing results of the third UE, resource scheduled by the third UE for the fourth UE, etc. In order to use the coordination information more effectively to improve the performance of the sidelink communication system, the coordination information can be used in the existing channel sensing (full sensing) process, as well as in the partial sensing and random selection process. The present embodiment provides a method for determining the transmission resource based on the channel sensing and the coordination information in the sidelink communication system.

In some embodiments, the fourth UE determines a resource allocation scheme based on the coordination information from the third UE (602). The third UE may be one UE or multiple UEs, such as a group of UEs corresponding to a group ID in multicast, and then, for example, a plurality of infrastructure nodes that periodically transmit coordination information within the communication range of the fourth UE. The third UE may also be replaced with a base station or a control/scheduling node in other sidelink system.

Wherein, the resource allocation scheme includes at least one of the followings: full sensing, partial sensing, random selection, re-evaluation and pre-emption, wherein the partial sensing includes the periodic-based partial sensing and the contiguous partial sensing.

Alternatively, the fourth UE determines a resource allocation scheme and/or whether to use the coordination information in the resource selection process based on at least one of the followings:
whether the coordination information is received;
whether the coordination information is received within a specific time range. The specific time range includes the time range [n-a, n-b] determined based on the specific offset on a time reference point n, in which the time point at which the fourth UE determines the resource for transmission, and/or the time point at which the fourth UE is triggered by the higher layer to perform resource selection, and/or the time point at which the data of the fourth UE arrives at the physical layer is used as the time reference point; where a and b are real numbers, and a and/or b can be determined based on UE capability and/or (pre-)configuration and/or service priority. The advantage of this method is that the time range can be used to determine the accuracy of the coordination information;
whether the coordination information is valid;
whether the coordination information comes from a specific UE; wherein, the specific UE may be the receiving end UE corresponding to the transmission of the fourth UE. The advantage of this method is that only the coordination information of the target user can be used to select the resource used for transmission to the target user;

The content of the coordination information includes at least one of the followings: resource preferred by the third UE, resource not preferred by the third UE, sensing results of the third UE, and resource scheduled by the third UE for the fourth UE.

The advantage of this method is that the reliability of the coordination information, or whether it can be used for a specific transmission (for example, when the target user of the specific transmission is the specific UE mentioned above), or whether it can be used for exclusion or reservation of resource can be determined according to some of the above criteria, so as to more appropriately use the coordination information in the resource determination process.

In a specific example, the fourth UE needs to transmit data to the third UE and is triggered by the higher layer in slot n for resource selection. If the fourth UE obtains valid coordination information from the third UE in the time range [n-a, n-b], and the coordination information indicates the resource preferred by the third UE and/or the resource scheduled by the third UE for the fourth UE, the fourth UE uses the random selection; otherwise, if the fourth UE obtains valid coordination information from the third UE in the time range [n-a, n-b], and the coordination information indicates resource not preferred by the third UE, the fourth UE uses the partial sensing; otherwise, if the fourth UE obtains the coordination information from the third UE in the time range [n-a, n-b], but the coordination information is invalid, or the fourth UE fails to obtain the coordination information from the third UE in the time range [n−a, n−b], the fourth UE uses the full sensing.

In some embodiments, the fourth UE needs to transmit the sidelink signal/channel and use the coordination information from the third UE in the sensing process, including using the coordination information to initialize the set of the candidate resources for the transmission. Specifically, it includes at least one of the followings:

The fourth UE generates a set of the candidate resources S_{A} for the sidelink signal/channel, and makes the resource preferred by the third UE indicated in the coordination information, the resource not excluded from the sensing results of the third UE, and/or the resource scheduled by the third UE for the fourth UE be included in the set of the candidate resources S_{A}; alternatively, the fourth UE uses the set of the resource preferred by the third UE indicated in the coordination information, the resource not excluded from the sensing results of the third UE, and/or the resource scheduled by the third UE for the fourth UE as the initial set of the candidate resources S_{A};

The fourth UE determines the time interval [n+T₁, n+T₂] for generating the set of the candidate resources S_{A} based on the coordination information (that is, the time interval that may include candidate resource R_{x,y}). Specifically, the upper limit and/or lower limit and/or specific value of T₁ and/or T₂ are determined according to the coordination information;

The fourth UE determines the minimum length of the time interval for generating the set of the candidate resources S_{A} and/or the minimum number of the candidate resources included in the set of the candidate resources S_{A} based on the coordination information.

This method can also be used in the resource selection process not based on sensing. For example, in the resource selection process based on the random selection, the method may be used to determine the set of the candidate resources in which random selection is performed.

The advantage of this method is that when the UE can determine the resource for transmission based on the coordination information, since certain channel interference status information has been provided in the coordination information, the UE can reduce the requirement for information collection by itself, and may also reduce the requirement for its own ability to process the collected information.

In a specific example, the upper/lower limit of T₁ is determined by 0≤T₁≤T_{proc,1}^{SL}, the upper/lower limit of T₂ is determined by T₂=remaining PDB and/or T₂ₘᵢₙ≤T₂≤remaining packet budget. In this example, the fourth UE determines at least one of the corresponding T_{proc,1}^{SL}, T₂ₘᵢₙ, and the remaining PDBs according to whether the coordination information exists/is available. For example, the upper layer of the fourth UE is configured with two values of T₂ₘᵢₙ, when the fourth UE receives the available coordination information, one of the values is used, otherwise the other value is used.

In some embodiments, the fourth UE needs to transmit the sidelink signal/channel and use the coordination information from the third UE in the sensing process, which further comprises: excluding the candidate resources from the set of the candidate sidelink resources S_{A} based on the coordination information. Specifically, it includes: excluding at least one of the followings from the set of the candidate sidelink resource S_{A} (may be the initial set of the candidate sidelink resource and/or the set of the candidate sidelink resource after the excluding of the candidate resources according to other criteria): the resource not preferred by the third UE and the resource that should be excluded based on the sensing results of the third UE. Alternatively, when the RSRP corresponding to the coordination information exceeds the preset threshold, the set of candidate sidelink resource is excluded from the set of the candidate sidelink resource S_{A} based on the coordination information.

In some embodiments, the fourth UE needs to transmit the sidelink signal/channel and use the coordination information from the third UE in the sensing process, which further comprises determining the sensing window corresponding to the transmission based on the coordination information. Specifically, it includes at least one of the followings:
the position of the start and/or the end of the sensing window is determined based on the coordination information. When the transmission corresponds to a plurality of sensing windows, determining the position of the start and/or the end of at least one or each sensing window. For example, the sensing window is [n−T₀, n−T_{proc,0}^{SL}], the value of T₀ and/or T_{proc,0}^{SL} is determined based on the coordination information;
the length of the sensing window and/or the length of the sensing window corresponding to at least one candidate resource R_{x,y} is determined based on the coordination information;
the position of the sensing window corresponding to at least one candidate resource R_{x,y} is determined based on the coordination information; for example, the sensing window corresponding to one candidate resource R_{x,y} is consist of one or more sensing occasions corresponding to the candidate resource. The one or more sensing occasions can be continuous or discrete in time domain and/or frequency domain, and the UE determines the value of the parameter used to calculate one or more sensing occasions based on the coordination information. In some embodiments, the fourth UE needs to transmit the sidelink signal/channel and use the coordination information from the third UE in the sensing process, which further comprises: at least one of the following parameters used in the sensing process is determined based on the coordination information: RSRP threshold for determining whether to exclude SCI of the candidate resources, threshold X and/or Mₜₒₜₐₗ and/or RSRP threshold Th(pᵢ,pⱼ) corresponding to priority for determining the number of remaining resources in the set S_{A} after the exclusion of the resources (which is used to determine whether the number of remaining resources is sufficient, and whether to re-execute resource exclusion after relaxing the RSRP threshold by 3 dB when the number of resources is lower than the threshold), the resource configured for re-evaluation and/or pre-emption, the priority parameters used in the pre-emption process, wherein the X may be a predetermined or (pre-)configured percentage parameter, the Mₜₒₜₐₗ refers to the total number of resource in the set of the candidates.

In other embodiments, the fourth UE needs to transmit the sidelink signal/channel and use the coordination information from the third UE in the resource determination process (including the resource selection process based on sensing and not based on sensing), which also includes at least one of the followings:
if the set of the candidate resources determined by the fourth UE itself overlaps with the set of the candidate resources determined by the fourth UE based on the obtained coordination information, the overlapped part is used as the final set of the candidate resources; alternatively, when the number of the candidate resources included in the overlapped part exceeds the threshold, the overlapped part is used as the final set of the candidate resources;
if the set of the candidate resources determined by the fourth UE itself does not overlap with the set of the candidate resources determined by the fourth UE based on the obtained coordination information, and/or the number of the candidate resources included in the overlapped part is lower than the threshold, triggering the re-execution of resource determination process by the fourth UE itself (that is, not based on coordination information). Alternatively, the value of a specific parameter is adjusted in this process, for example, for the resource determination process based on the sensing, the RSRP threshold of SCI for determining whether to exclude candidate resources will be increased by x dB, and/or the threshold X·Mₜₒₜₐₗ of the number of remaining resources in the set S_{A} after determining the resource exclusion will be increased by y %; for another example, the minimum length of time interval for generating the set of the candidate resources S_{A} and/or the minimum number of the candidate resources included in the set of the candidate resources S_{A} is adjusted;
if the set of the candidate resources determined by the fourth UE itself does not overlap with the set of the candidate resources determined by the fourth UE based on the obtained coordination information, and/or the number of the candidate resources included in the overlapped part is lower than the threshold, triggering the third UE to regenerate and transmit the coordination information; alternatively, the reason for the trigger, and/or the time range (or the latest time point) for retransmitting the coordination information, and/or a specific time range and/or resource size and/or service priority which is used to enable the third UE generate coordination information based on this are indicated when triggered; alternatively, this method is used when the latency parameters corresponding to the transmission of the fourth UE, such as the remaining PDB, meet the specific threshold range;
if the set of the candidate resources determined by the fourth UE itself does not overlap with the set of the candidate resources determined by the fourth UE based on the obtained coordination information, and/or the number of the candidate resources included in the overlapped part is lower than the threshold, one of the set of the candidate resources determined by the fourth UE itself and the set of the candidate resources determined by the fourth UE based on the obtained coordination information is used. Alternatively, determining which one of the set of the candidate resources determined by the fourth UE itself and the set of the candidate resources determined by the fourth UE based on the obtained coordination information is used based on at least one of the transmission type (cast type), service priority and the identity of the third and/or fourth UE.

In other embodiments, since the fourth UE can obtain the coordination information from one or more third UEs and use it in the resource determination process, the fourth UE using the coordination information in the resource determination process (including the resource selection process based on sensing and the resource selection process not based on sensing) further comprises:
the coordination information indicates the resource that the third UE does not prefer and/or the resource that should be excluded based on the sensing result of the third UE. The fourth UE excludes the resource that the third UE does not prefer and/or the resource that should be excluded based on the sensing result of the third UE from the set of the candidate resources based on the above types of content in the coordination information of each third UE; alternatively, if the number of the candidate resources remaining after exclusion is lower than the threshold, performing at least one of the followings:
triggering the re-execution of resource determination process by the fourth UE itself (that is, not based on coordination information); alternatively, the value of specific parameter is adjusted in the process, for example, for the resource determination process based on the sensing, the RSRP threshold of SCI for determining whether to exclude candidate resources will be increased by x dB, and/or the threshold X·Mₜₒₜₐₗ of the number of remaining resources in the set S_{A} after determining the resource exclusion will be increased by y %; for another example, the minimum length of time interval for generating the set of the candidate resources S_{A} and/or the minimum number of the candidate resources included in the set of the candidate resources S_{A} is adjusted;
triggering the third UE to regenerate and transmit the coordination information; alternatively, the reason for the trigger, and/or the time range (or the latest time point) for retransmitting the coordination information, and/or a specific time range and/or resource size and/or service priority which is used to enable the third UE generate coordination information based on this are indicated when triggered; alternatively, this method is used when the latency parameters corresponding to the transmission of the fourth UE, such as the remaining PDB, meet the specific threshold range.

In other embodiments, since the fourth UE can obtain coordination information from a plurality of third UEs and use it in the resource determination process, the fourth UE using the coordination information in the resource determination process (including the resource selection process based on sensing and the resource selection process not based on sensing) further comprises:
the coordination information indicates the resource preferred by the third UE and/or the resource not excluded based on the sensing result of the third UE. The fourth UE selects the intersection of the resource preferred by each third UE and/or the resource not excluded based on the sensing result of the third UE as the candidate resource or the resource actually used for transmission based on the above types of content in the coordination information of each third UE.

Alternatively, if the intersection of resource preferred by each third UE and/or resource not excluded based on the sensing result of the third UE does not exist, or exists but the number is lower than the threshold, performing at least one of the followings:
triggering the re-execution of resource determination process by the fourth UE itself (that is, not based on coordination information); alternatively, the value of specific parameter is adjusted in the process, for example, for the resource determination process based on the sensing, the RSRP threshold of SCI for determining whether to exclude candidate resources will be increased by x dB, and/or the threshold X·Mₜₒₜₐₗ of the number of remaining resources in the set S_{A} after determining the resource exclusion will be increased by y %; for another example, the minimum length of time interval for generating the set of the candidate resources S_{A} and/or the minimum number of the candidate resources included in the set of the candidate resources S_{A} is adjusted;
triggering the third UE to regenerate and transmit the coordination information; alternatively, the reason for the trigger, and/or the time range (or the latest time point) for retransmitting the coordination information, and/or a specific time range and/or resource size and/or service priority which is used to enable the third UE generate coordination information based on this are indicated when triggered; alternatively, this method is used when the latency parameters corresponding to the transmission of the fourth UE, such as the remaining PDB, meet the specific threshold range.

In other embodiments, the fourth UE needs to transmit the sidelink signal/channel and use the coordination information from the third UE in the resource determination process (including the resource selection process based on sensing and the resource selection process not based on sensing), which further comprises: there is a predetermined gap between the determined at least two items of the followings: a sensing window, a resource selection window, a set of the candidate resources, a time interval that may include candidate resources, a time for receiving coordination information, a time range for receiving coordination information, a DRX-on period (or at least one DRX timer running period), DRX-off period (or a period during which no DRX timers are running/all DRX timers have been expired). Alternatively, if the time of the determined at least two items does not meet the predetermined gap, the position of the former and/or the latter of the at least two items is adjusted so that the at least two items meet the gap.

In other embodiments, the fourth UE uses the coordination information in the resource determination process, which further comprises:
if the UE can expect to receive the coordination information in a specific resource range, and/or the UE can use the coordination information in the resource selection process, and if the UE enables the full sensing and/or the partial sensing, the UE can skip the sensing before the specific resource range.

Alternatively, it further comprises: if the UE skips the sensing before the specific resource range, but actually fails to receive the coordination information within the specific resource range, and/or cannot use the received coordination information in the resource selection process, the UE performs any of the followings:
using the random selection (optionally, if the UE is configured to use the random selection);
using a method similar to that in other embodiments in this specification, determining whether the full sensing and/or the partial sensing can be used according to at least one of the followings, if the full sensing and/or the partial sensing cannot be used, using the random selection (optionally, if the UE is configured to use random selection): the resource allocation scheme indicated in the configuration, the type of the sidelink signal/channel, the priority corresponding to the sidelink signal/channel, the latency corresponding to the sidelink signal/channel, the previous sensing result and/or the existing sensing result and/or the sensing result that can be used for transmission of the sidelink signal/channel, the previous resource used for sensing and/or the existing resource used for sensing and/or the resource used for sensing that can be used for transmission of the sidelink signal/channel, whether the available resources and/or the unavailable resources and/or the sensing results being obtained, DRX configuration and power saving status.

Alternatively, in this embodiment, after the UE determines to the use random selection/the full sensing/the partial sensing, it can also determine whether to additionally use the re-evaluation and/or the pre-emption according to the methods in other embodiments in this specification.

In a specific example, the UE is configured to enable the partial sensing and the random selection. If the UE obtains TB1 from the higher layer in slot n and the higher layer also provides a resource reservation period Tᵣₛᵥₚ, the UE expects to transmit the next TB (called TB2) on slot n+Tᵣₛᵥₚ, and needs to determine the sensing window corresponding to TB2. The UE determines that the sensing window of TB2 includes [n+Tᵣₛᵥₚ−a1, n+Tᵣₛᵥₚ−a2]. If the UE expects to receive the coordination information on slot n1, and if the coordination information can be used to determine the transmission resource of TB2 (for example, when the UE transmitting the coordination information is the receiving UE of TB2, the coordination information can be used to determine the transmission resource of TB2), the UE skips the sensing before slot n1, that is, the UE does not perform sensing on the part of [n+Tᵣₛᵥₚ−a1, n1] of the sensing window(assuming n+Tᵣₛᵥₚ−a1<n1).

If the UE actually fails to receive the coordination information on slot n1, or the received coordination information cannot be used to determine the transmission resource of TB2, then: if the priority of TB2 is higher than a specific threshold, the UE determines whether to use the partial sensing based on the latency corresponding to TB2, the previous sensing result and/or the existing sensing result and/or the sensing result that can be used for transmission of the TB2, the previous resource used for sensing and/or the existing resource used for sensing, and/or the resource used for sensing that can be used for transmission of TB2. If the partial sensing cannot be used, the random selection is used; otherwise, if the priority of TB2 is not higher than the specific threshold, the UE uses the random selection.

Specifically, the UE determining the previous resource used for sensing and/or the existing resource used for sensing and/or the resource used for sensing that can be used for transmission of TB2 comprises:
a partial sensing window [n1+T_{process1}, n+Tᵣₛᵥₚ−a2] between the time point when it is determined that the coordination information cannot be received and the time point when TB2 arrives, where T_{process1} is the UE processing latency;
alternatively, a partial sensing window [n+Tᵣₛᵥₚ+T_{process2}, n2] after the time point when TB2 arrives, which may exist only when the remaining PDB corresponding to TB2 exceeds the threshold and/or the priority corresponding to TB2 meets a specific threshold range, where T_{process2} is the UE processing latency;
in the partial sensing window [n+Tᵣₛᵥₚ−a1, n1] before determining the time point at which the coordination information cannot be received, the received and buffered resource have been performed; for example, it may be the resource on which the UE has buffered for the sensing of other TB.

If the UE determines that the total number of the resources used for sensing exceeds a given threshold, the UE determines that the partial sensing can be used, otherwise the partial sensing cannot be used.

FIG. 7 illustrates a structure of a UE according to an embodiment of the disclosure.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UE of the FIG. 3a.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

FIG. 8 illustrates a structure of a base station according to an embodiment of the disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor. Furthermore, the base station of FIG. 8 corresponds to the BS of the FIG. 3b.

The transceiver 810 collectively refers to a base station receiver and a base station transmitter, and may transmit/receive a signal to/from a terminal(UE) or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

The application provides a method for the UE to assist other nodes in selecting resource, which helps other nodes to select resource more efficiently and avoid possible interference caused by hidden node problems in sidelink communication.

The application also discloses an electronic device, comprising: a memory, which is configured to store a computer program; and a processor, which is configured to read the computer program from the memory and run the computer program to implement the above method.

The term “module” may indicate a unit including one of hardware, software, firmware, or a combination thereof. The term “module” can be used interchangeably with the terms “unit”, “logic”, “logic block”, “component” and “circuit”. The term “module” may indicate the smallest unit or part of an integrated component. The term “module” may indicate the smallest unit or part that performs one or more functions. The term “module” refers to a device that can be implemented mechanically or electronically. For example, the term “module” may indicate a device including at least one of an application specific integrated circuit (ASIC), a field programmable gate array (FPGA), or a programmable logic array (PLA) that performs certain operations, which are known or will be developed in the future.

According to an embodiment of the present disclosure, at least a part of a device (for example, a module or its function) or a method (for example, an operation) may be implemented as instructions stored in a non-transitory computer-readable storage medium, for example, in the form of a programming circuit. When run by a processor, instructions can enable the processor to perform corresponding functions. The non-transitory computer-readable storage medium may be, for example, a memory.

Non-transitory computer-readable storage media may include hardware devices such as hard disks, floppy disks, and magnetic tapes (for example, magnetic tapes), optical media such as compact disk read-only memory (ROM) (CD-ROM) and digital versatile disk (DVD), magneto-optical media such as optical disks, ROM, random access memory (RAM), flash memory, etc. Examples of program commands may include not only machine language codes, but also higher layer language codes that can be executed by various computing devices using an interpreter. The aforementioned hardware devices may be configured to operate as one or more software modules to perform the embodiments of the present disclosure, and vice versa.

The circuit or programming circuit according to various embodiments of the present disclosure may include at least one or more of the aforementioned components, omit some of them, or further include other additional components. Operations performed by the circuits, programming circuits, or other components according to various embodiments of the present disclosure may be performed sequentially, simultaneously, repeatedly, or heuristically. In addition, some operations may be performed in a different order, or omitted, or include other additional operations.

The embodiments of the present disclosure are described to facilitate understanding of the present disclosure, but are not intended to limit the scope of the present disclosure. Therefore, the scope of the present disclosure should be construed as including all changes or various embodiments based on the scope of the present disclosure defined by the appended claims and their equivalents.

1-15. (canceled)

16. A method performed by a first terminal in a wireless communication system, the method comprising:
receiving, from a base station, information on a resource reservation period for a sidelink transmission and information on a value associated with a window length of a contiguous partial sensing;
identifying a scheme for a sidelink resource allocation based on the resource reservation period and the value;
in case that the resource reservation period is not zero, performing the contiguous partial sensing for the sidelink resource allocation;
in case that a number of logical slots for sensing is equal to or more than the value, performing the contiguous partial sensing for the sidelink resource allocation according to the window length; and
in case that the number of logical slots for sensing which is equal to or more than the value is not guaranteed, performing a random selection for the sidelink resource allocation.

17. The method of claim 16, wherein the scheme for the sidelink resource allocation is one of a full sensing, the contiguous partial sensing, a periodic based partial sensing, or the random selection.

18. The method of claim 17, further comprising:
receiving, from the base station, information configuring the full sensing, a partial sensing, or the random selection.

19. The method of claim 16, further comprising:
in case that the resource reservation period is zero, performing the random selection for the sidelink resource allocation.

20. The method of claim 16, further comprising:
transmitting, to a second terminal, a data on a physical sidelink shared channel (PSSCH) identified based on the sidelink resource allocation.

21. The method of claim 16, further comprising:
receiving, from the base station, coordination information indicating a non-preferred resource,
wherein the non-preferred resource is excluded for the sidelink resource allocation.

22. The method of claim 16, further comprising:
receiving, from a second terminal, coordination information indicating a preferred resource; and
identifying an intersection of the preferred resource and a candidate resource identified by the first terminal for a PSSCH transmission.

23. The method of claim 22, wherein, in case that there is at least one resource within the intersection, a resource for the PSSCH transmission is selected among the at least one resource.

24. The method of claim 22, wherein, in case that there is no resource within the intersection, a resource for the PSSCH transmission is selected among the candidate resource identified by the first terminal.

25. The method of claim 16, wherein a periodic based partial sensing is performed during a sidelink discontinuous reception (DRX) inactive time.

26. A first terminal in a wireless communication system, the first terminal comprising:
a transceiver; and
a controller coupled with the transceiver and configured to:
receive, from a base station, information on a resource reservation period for a sidelink transmission and information on a value associated with a window length of a contiguous partial sensing,
identify a scheme for a sidelink resource allocation based on the resource reservation period and the value,
in case that the resource reservation period is not zero, perform the contiguous partial sensing for the sidelink resource allocation,
in case that a number of logical slots for sensing is equal to or more than the value, perform the contiguous partial sensing for the sidelink resource allocation according to the window length, and
in case that the number of logical slots for sensing which is equal to or more than the value is not guaranteed, perform a random selection for the sidelink resource allocation.

27. The first terminal of claim 26, wherein the scheme for the sidelink resource allocation is one of a full sensing, the contiguous partial sensing, a periodic based partial sensing, or the random selection.

28. The first terminal of claim 27, wherein the controller is further configured to receive, from the base station, information configuring the full sensing, a partial sensing, or the random selection.

29. The first terminal of claim 26, wherein the controller is further configured to in case that the resource reservation period is zero, perform the random selection for the sidelink resource allocation.

30. The first terminal of claim 26, wherein the controller is further configured to:
transmit, to a second terminal, a data on a physical sidelink shared channel (PSSCH) identified based on the sidelink resource allocation.

31. The first terminal of claim 26, wherein the controller is further configured to:
receive, from the base station, coordination information indicating a non-preferred resource, and
wherein the non-preferred resource is excluded for the sidelink resource allocation.

32. The first terminal of claim 26, wherein the controller is further configured to:
receive, from a second terminal, coordination information indicating a preferred resource, and
identifying an intersection of the preferred resource and a candidate resource identified by the first terminal for a PSSCH transmission.

33. The first terminal of claim 32, wherein, in case that there is at least one resource within the intersection, a resource for the PSSCH transmission is selected among the at least one resource.

34. The first terminal of claim 32, wherein, in case that there is no resource within the intersection, a resource for the PSSCH transmission is selected among the candidate resource identified by the first terminal.

35. The first terminal of claim 26, wherein a periodic based partial sensing is performed during a sidelink discontinuous reception (DRX) inactive time.
